(19) United States
(12) Patent Application Publication
(10) Pub. No.: US 2010/0127658 A1
(43) Pub. Date: May 27, 2010

(54) CHARGING CIRCUIT FOR CHARGING TWO BATTERIES

(76) Inventor: Andras Fazakas, Budapest (HU)

Correspondence Address: FITCH, EVEN, TABIN & FLANNERY, P. O. BOX 18415, WASHINGTON, DC, 20036, US

(21) Appl. No.: 12/597,405

(22) PCT Filed: Apr. 24, 2008
(86) PCT No.: PCT/HU08/00039

§ 371 Date: Oct. 23, 2009

(30) Foreign Application Priority Data
Apr. 24, 2007 (HU) P0700299

(51) Int. Cl. H01M 10/46

(52) U.S. Cl. 320/101

(57) ABSTRACT

Charging circuit for charging two batteries with a mains transformer having a primary and a secondary winding, both end terminals of the secondary winding are connected with respective capacitive circuits, wherein terminals of identical polarity of the respective capacitive circuits are connected to the end terminals of the secondary winding and each of the capacitive circuits comprises at least one electrolytic capacitor of high capacitance value and a diode connected in reverse direction, and at least the other terminal of one of the capacitive circuits is connected with a common point of two diodes connected in series with each other, and the two remaining free electrodes of the two diodes (D1, D2) are coupled to at least two of the altogether four terminals of the two batteries (B1, B2), and the second terminal of the other capacitive circuit with opposite polarity is connected directly or through a further diode (D5) to the fourth battery terminal.

The invention relates to a charging circuit for charging two batteries that comprises a mains transformer with a primary and a secondary winding, both end terminals of the secondary winding are connected with terminals of identical polarity of respective capacitive circuits and each of the capacitive circuits comprises at least one electrolytic capacitor of high capacitance value and a diode connected in reverse direction, and at least the other terminal of one of the capacitive circuits is connected with a common point of two diodes connected in series with each other.

In the international publication WO 01/06614 a battery charger circuit of the above described type is described, wherein the actual charging voltage is the vectorial sum of the voltages of a charged electrolytic capacitor and of an energized inductance. The energized inductance is realized by the secondary winding of a mains transformer. The circuit utilizes both half periods of the mains voltage and provides a unique high-current charging. The fact that one component of the output voltage is constituted by the voltage on a charged capacitor provides a certain flexibility for the charging, since any short circuit that might occur in the battery cannot damage the charger, and the charging process itself is sufficiently controlled by the actual battery voltage.

This circuit has several preferred properties but one drawback lies in that owing to the full-wave operation a high number of components is used, although for several other charging applications a simpler and cheaper but similarly flexible charger circuit would be sufficient even if it could provide a slower charging and would be inappropriate for being used as a fast charger.

The control of this conventional charger was realized among other ways by changing the capacitance value of the electrolytic capacitors used. In view of the high current peaks that take place during operation the insertion of such capacitors requires the use of special semiconductor switches that can slightly limit the current peaks. Such a preferable semiconductor switching circuit is described in the international publication WO 2005/078888.

The charging of batteries with high storage capacity is generally required at professional users where a larger number of batteries are used and where the efficiency of the charging of batteries is not only decided by the time and energy required for charging a particular battery but it is also taken into account if a battery charger is capable of charging simultaneously more than one battery. In this respect a charging circuit can be regarded equivalent with a different other battery charger that can fully charge two batteries in double time if its energy consumption is the same as that of the first charger. Of these two types of battery charging circuits the version which is simpler and cheaper will be the preferred one.

The object of the invention is to provide a battery charger circuit for charging two batteries which from the point of view of the previously outlined comparison is at least as good as the charger circuit described in the aforementioned international publication WO 01/06614 and it can be used preferably in larger users because it can charge two batteries at the same time.

This objective has been solved by providing a charging circuit for charging two batteries that comprises a mains transformer with a primary and a secondary winding, both end terminals of the secondary winding are connected with terminals of identical polarity of respective capacitive circuits and each of the capacitive circuits comprises at least one electrolytic capacitor of high capacitance value and a diode connected in reverse direction, and at least the other terminal of one of the capacitive circuits is connected with a common point of two diodes connected in series with each other, furthermore the two remaining free electrodes of these two diodes are coupled to at least two of the altogether four terminals of the two batteries, and the second terminal of the other capacitive circuit with opposite polarity is connected directly or through a further diode to the fourth battery terminal.

In an embodiment which is capable of charging two substantially identical storage capacities the two batteries are connected in series with each other, and the two end terminals of the series arrangement is connected to the free ends of these two diodes and the second terminal of the other capacitive circuit is coupled to the interconnected terminals of the two batteries.

For the sake of creating optimum conditions for the correct operation the charging circuit further comprises an equalizer circuit that provides respective adjustable loads to the batteries for decreasing any sensed voltage difference between the terminal voltages thereof.

In a preferable embodiment the capacitive circuits have substantially identical capacitance values.

In a further embodiment designed for charging two independent batteries the two free electrodes of the two diodes are connected the two terminals of one of the batteries, and one of these terminals is grounded, furthermore the second terminal of the second capacitive circuit is connected to a common point of two further diodes connected in series, and of the two free ends of these two further diodes the first free end is connected to the ground and to a first terminal of the second battery, and the other free end is coupled to the second terminal of the second battery.

In the capacitive circuits the at least one capacitor has a capacitance of at least 100 μF but preferably much higher, and at least one further electrolytic capacitor of similarly high capacitance can be connected in parallel with the first capacitor by means of respective controlled semiconductor switches.

For adjusting the power and the output voltage it is preferable if at least one of the windings of the transformer has a plurality of tapped winding terminals selectable by respective associated switches.

The invention will now be described in connection with preferable embodiments thereof, wherein reference will be made to the accompanying drawings.

In the drawing:

FIG. 1 is the circuit diagram of a first embodiment of the battery charger circuit according to the invention;

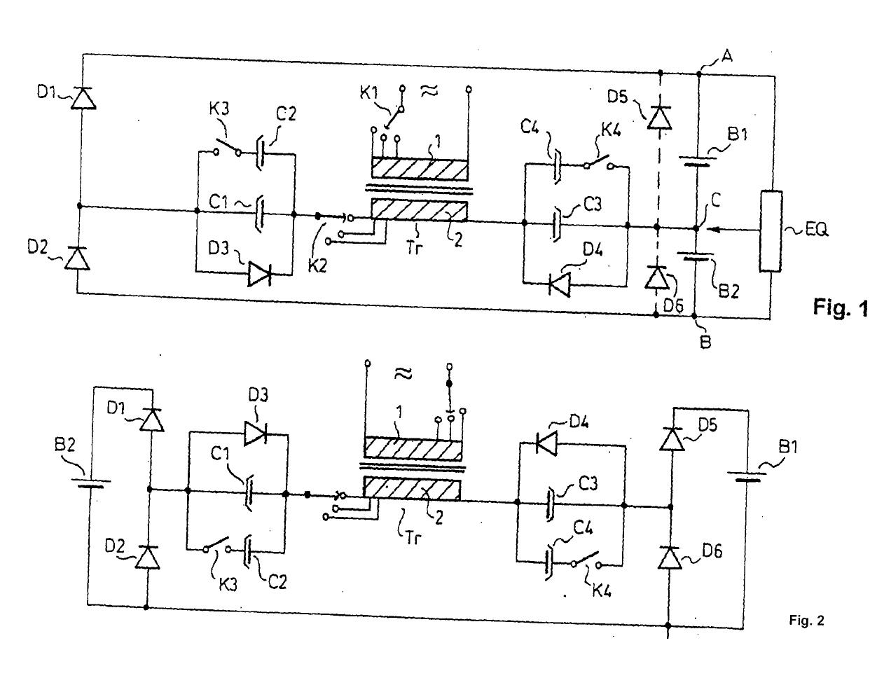

FIG. 2 is the circuit diagram of a further embodiment in which the charging of the two batteries is practically independent from each other; and

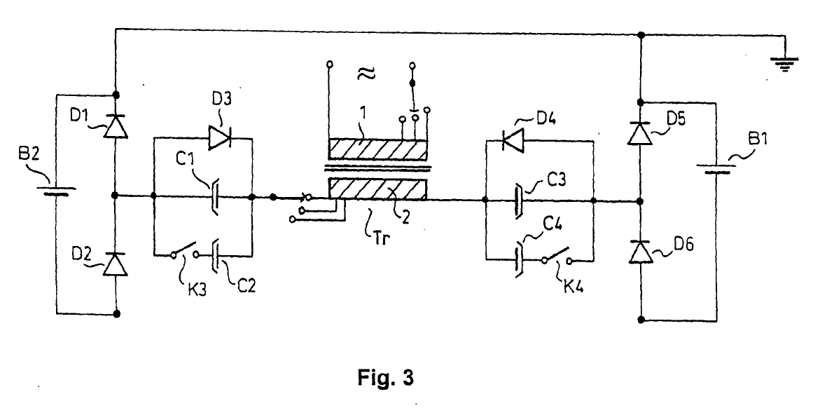

FIG. 3 is an alternative version of the embodiment of FIG. 2.

The battery charger circuit shown in FIG. 1 comprises a mains transformer Tr having a primary winding 1 with multiple tap lead out terminals and a secondary winding 2 also with a plurality of tap lead out terminals. The primary winding 1 is connected to a single phase alternating mains network in the winding section selected by switch K1, and the secondary winding 2 also has an active winding section that can be selected by switch K2. The switch K2 is coupled to a first (positive) terminal of electrolytic capacitors C1 and C2 that both have high capacitance (being at least 100 μF or preferably much higher, even ten or 20 times higher). The electrolytic capacitor C2 can be connected parallel with the capacitor C1 (and be disconnected therefrom) by means of a semiconductor switch K3. It should be noted that by means of further similar semiconductor switches further electrolytic capacitors (not shown) can be connected in parallel with the capacitor C1. The capacitance value required for the correct operation can be adjusted my means of the switch K3 and the further similar switches. The switch K3 can be designed preferably as described in the previously referred international publication WO 2005/078888. The other (negative) terminal of the parallel electrolytic capacitors C1 and C2 is connected to anode of diode D1 and cathode of diode D2. Parallel to the capacitors C1 a diode D3 with reverse polarity is connected which prevents the application of a voltage with reverse polarity on the electrolytic capacitors, and it cannot allow the flow of current in the reverse direction. The other end terminal of the secondary winding 2 a circuit is connected which comprises electrolytic capacitors C3 and C4 and a protection diode D4, wherein the electrolytic capacitor C4 can be connected and disconnected by means of semiconductor switch K4 similar to the switch K3. The two outer (i.e. not connected) electrodes of the diodes D1 and D2 represent the connection terminals A and B of the charger circuit to the battery or batteries to be charged, and in the embodiment shown two batteries B1 and B2 of identical type and storage capacitance have been used. The connected common line of the batteries B1 and B2 forms the third connection terminal C of the battery charger circuit coupled to the terminal of the capacitors C3 and C4 which is other than the one connected to the secondary winding 2. The charging circuit according to the invention has the three connection terminals A, B and C that lead to the two batteries B1 and B2.

It should be noted that during the charging process attention should be paid to keep the charged states of the two batteries B1, B2 preferably on identical level which has a greater significance at the end region of the charging process, i.e. when the batteries have almost been fully charged. For achieving this condition it is advisable to connect an equalizer circuit EQ which monitors the instantaneous voltages of both batteries an in case the voltage on one battery is higher than that n the other, it connects a load on the battery with higher voltage, wherein the load depends also on the voltage difference. The load will be disconnected if the two battery voltages will again be equal. Such equalizers are per se known circuits and their actual design does not belong to the present invention.

In FIG. 1 the dash lines between the terminals A, B and C show a pair of diodes D5 and D6, wherein their presence does not exert a remarkable influence on the operation.

The operation of the charging circuit of FIG. 1 assumes that the batteries B1 and B2 to be charged have the same type, storage capacity and to store the same amount of charge during the charging process. The nominal voltage between the terminals A and B is the twice of the secondary voltage, therefore it is advisable to design the secondary winding 2 to deliver a voltage that can be adjusted between about 0.3 to 0.5 times of the voltage needed between the terminals A and B. By the appropriate selection of the active winding sections of the primary and secondary windings both the charging voltage and the charging power can be adjusted, while the adjustment of the overall capacitance of the capacitors in the first place the charging power can be changed.

The operation of the circuit shown in FIG. 1 can be understood if it is considered that following the initial transient processes after the circuit has been switched on the current flowing in the secondary winding 2 reverses its direction in each half period of the mains frequency, and the current will flow either through the diode D1 or through the diode D2. A condition of the flow of the current is that the voltage between the terminals A and B is smaller than the sum of the momentary secondary voltage and the voltage on the parallel capacitors. When the secondary voltage increases, the charges stored in the series capacitor will discharge through the batteries to be charged. The conditions change in each half period. An advantage of this circuit lies in that both half periods of the mains supply are utilized for charging, although the respective individual batteries B1 and B2 are charged only during a half period of each cycle, but this process is repeatedly changes between the two batteries. The energy supplied by the transformer Tr is fully utilized in both half periods as in case of full-wave chargers, and in the charging circuit referred to in the previously mentioned international publication WO 01/06614, but in the present case two batteries are charged but each with half energy. The number of the electrolytic capacitors used is the same as the number of electrolytic capacitors used in this reference charger circuit designed for charging a single battery, and the number of diodes used is smaller. The circuit according to the invention uses the same amount of components and it is capable of charging twice as many batteries, but the individual charging processes require a somewhat longer time. The energy utilization is, however, preferable as both half periods have been utilized.

A limitation of the application of the charging circuit of FIG. 1 lies in the required identity of the two batteries to be charged, therefore the circuit cannot be used as if a single charger would be appropriate to charge two independent batteries in an independent way.

For such independent charging tasks the solution shown in FIG. 2 can be used which has a great degree of similarity with the circuit of FIG. 1, therefore the corresponding components and elements were designated by identical reference symbols. The difference lies in that in the present circuit the use of the diodes D5, D6 is always required and the voltage of the secondary winding 2 should be designed to correspond to the terminal voltage of the batteries B1, B2 (and not to correspond to the sum of the two battery voltages), and in the respective charging half-periods the respective paths of the charging currents will always flow through different pairs of diodes (D1-D6, resp. D2-D5). In the present case the equalizer circuit is not necessary because the charging of the two batteries takes place in mutually offset half-periods and the charging circuit can be regarded as if in the same casing to independent charging circuits were arranged. The energy utilization of this embodiment is just as preferably as in case of the circuit shown in FIG. 1 when simultaneously two batteries are charged.

A circuit variation of this second embodiment is shown in FIG. 3, and this circuit can be designed in such a way that the positive terminals of the batteries B1 and B2 are interconnected and connected to the ground (i.e. the cathodes of the diodes D1 and D5) and the line interconnecting the diodes D2 and D6 and the connection to the ground should be broken. In this way this variation differs from the circuit shown in FIG. 2 in that the positive battery terminals are grounded and the negative terminals are separated, otherwise the design and operation are the same as in case of the circuit of FIG. 2.

The charging circuit according to the invention is an ideal solution for users that apply a plurality of batteries, because a single charging circuit can charge two batteries simultaneously with full utilization of the available energy and the number of components is only half compared to the case of using a single conventional battery charging circuit.

A further advantage lies in that with the battery to be charged always an electrolytic capacitor with high capacitance is connected in series and this property is the source of a number of preferred properties including the applicability of the charger circuit, the shape of the charging pulses and finally the automatic control of the charging process as a function of the actual battery voltage.

1. Charging circuit for charging two batteries (B1, B2) comprising a mains transformer (Tr) having a primary winding (1) and a secondary winding (2), both end terminals of the secondary winding (2) are connected with respective capacitive circuits, wherein terminals of identical polarity of the respective capacitive circuits being connected to said end terminals of the secondary winding (2), and each of the capacitive circuits comprises at least one electrolytic capacitor (C1 or C2) of high capacitance value and a diode (D3 or D4) connected in reverse direction, and at least the other terminal of one of said capacitive circuits being connected with a common point of two diodes (D1, D2) connected in series with each other, characterized in that the two remaining free electrodes of said two diodes (D1, D2) are coupled to at least two of the altogether four terminals of the two batteries (B1, B2), and the second terminal of the other capacitive circuit with opposite polarity is connected directly or through a further diode (D5) to the fourth battery terminal.

2. The charging circuit as claimed in claim 1, characterized by being arranged for charging two batteries (B1, B2) having substantially identical storage capacities, wherein said batteries (B1, B2) being connected in series with each other and the two end terminals of the series arrangement is connected to said free ends of said two diodes (D1, D2) and said second terminal of the other capacitive circuit is coupled to the interconnected terminals of said two batteries (B1, B2).

3. The charging circuit as claimed in claim 2, characterized by further comprising an equalizer circuit (EQ) that provides respective adjustable loads to said batteries (B1, B2) for decreasing any sensed voltage difference between the terminal voltages of said batteries (B1, B2).

4. The charging circuit as claimed in claim 2, wherein said capacitive circuits have substantially identical capacitances.

5. The charging circuit as claimed in claim 1, characterized by being arranged for charging two independent batteries and said two free electrodes of said two diodes (D1, D2) being connected the two terminals of one of said batteries (B1), and one of these terminals is grounded, furthermore said second terminal of said second capacitive circuit is connected to a common point of two further diodes (D5, D6) connected in series, and of the two free ends of said two further diodes (D5, D6) the first free end is connected to the ground and to a first terminal of the second battery (B2) and the other free end is coupled to the second terminal of said second battery (B2).

6. The charging circuit as claimed in claim 1, wherein said at least one capacitor (C1) in said capacitive circuits has a capacitance of at least 100 μF but preferably much higher and at least one further electrolytic capacitor (C2 or C4) of similarly high capacitance can be connected in parallel with said first capacitor (C1) by means of respective controlled semiconductor switches (K3, K4).

7. The charging circuit as claimed in claim 1, wherein at least one of said windings (1, 2) of said transformer (Tr) has a plurality of tapped winding terminals selectable by respective associated switches (K1, K2).
